(19) United States
(12) Patent Application Publication
(10) Pub. No.: US 2003/0014294 A1
(43) Pub. Date: Jan. 16, 2003

(54) Job offer/job seeker information processing system

(76) Inventors: Hiroyuki Yoneyama, Fujisawa (JP); Kaname Nishiwaki, Fujisawa (JP); Takanori Udagawa, Fujisawa (JP); Yoichi Enomoto, Fujisawa (JP)

Correspondence Address: McGinn & Gibb, Suite 200, 8321 Old Courthouse Road, Vienna, VA, 22182-3817, US

(21) Appl. No.: 10/220,144

(22) PCT Filed: Feb. 7, 2001
(86) PCT No.: PCT/JP01/00862

(30) Foreign Application Priority Data
Feb. 29, 2000 (JP) 2000-54165

(51) Int. Cl. G06F 17/60

(52) U.S. Cl. 705/8

(57) ABSTRACT

A computer system capable of efficiently processing recruitment and job search information will be provided. The system comprises a recruiting party server 30 capable of being accessed through a communication network, provided with different URLs for respective recruiting parties on the communication network, wherein recruitment information will be transferred to a client computer 10 that accesses the server to have the information displayed on the computer 10 and prompt for registration on a database; transferring means for transferring entered applicant information by means of the client computer 10 through the communication network; and a management server 40 provided with an applicant database 410 for storing the applicant information transferred by the transferring means separately for each recruiting party, wherein the applicant information stored in the applicant database 410 is managed and administered at the management server 40 separately for each recruiting party.

### TECHNICAL FIELD

The present invention relates to a system for processing recruitment and job search information utilizing a communication network such as the Internet.

### BACKGROUND ART

In recent years, an increasing volume of recruitment and job search activities are conducted through the Internet, and accordingly various forms of information processing for the recruitment and job search utilizing the Internet to be implemented by intermediary agencies between those recruiting people and those seeking jobs have been proposed. For example, in the case of an information exchange mediating device disclosed in the publication of Japanese Patent Laid-Open No. 10-232893, job seekers access an intermediary server machine through the Internet to register themselves onto an individual membership list and a job search information database, and companies recruiting new employees also sign up through the Internet or otherwise through a contract in writing to participate in the system. Then, people looking for new jobs with hopes of moving to another company access the intermediary server machine through the Internet so that they may search and view information from the participating companies stored on the machine, and person in charge of the participating companies may access the intermediary server machine through the Internet to view and search information in a job search information database. Furthermore, in this intermediary device, people wishing to move to new companies are registered as anonymous members, and when participating companies search and view information, their names, addresses, cover addresses, and the like will not be disclosed.

Besides the one described in this publication, there already exist several systems for mediating job placement utilizing intermediary server machines through the Internet.

However, systems for processing recruitment and job search information utilizing intermediary server machines in the prior art have the following problems.

Since a participating company recruiting new employees is merely a member of these systems, they can only present uniform contents bound by the systems to job seekers. Thus, the systems do not allow each company to fully express its own characters and uniqueness. Since data of job seekers is also bound by the systems, each company cannot necessarily obtain desired data from job seekers.

Moreover, it is likely that the main purpose for a job seeker to sign up for the system will be to search for companies that would match desired conditions among many participating companies, rather than to find a job at a particular company. Therefore, frivolous contact to companies would become frequent (particularly for the system as described in the publication of Japanese Patent Laid-Open No. 10-232893, such frivolous contact is likely to become more frequent as job seekers are anonymous members). As the companies cannot distinguish frivolous contact from serious one, a heavy load would be placed on the screening capacity of those in charge of recruitment of the companies.

As opposed to resorting to such intermediary systems, a company recruiting new employees also uses a home page on its Web sites to provide a recruitment section for displaying recruitment information or to create a registration screen for job applicants, storing registration information in a database of the company's server machine. Such a system is advantageous in that it allows a company to express its own character and uniqueness, presents a desired content, obtain desired information from job applicants, and construct a database of applicants with a relatively firm wish to find a job at the company.

However, when a company processes recruitment and job search information with such a server, updating of job opening announcement, answering to those who signed up, and management of the constructed database have to be performed by person in charge of the company. The system has a problem in terms of work and cost it requires. For example, while it is a person in charge of recruitment who knows details of recruitment information and job positions targeted by the recruitment, the actual work of updating its homepage must be carried out by an IT specialist. As the IT specialist is typically also in charge of other works, the updating work tends to fall behind such that often information presented would not hot.

Also much effort is required for screening those who signed up, managing the constructed database, and maintaining the system with a result that currently high costs are borne by companies recruiting new employees. For example, typically a hiring process has to go through selection based on submitted documents, holding of a seminar, interviews (first, second, third . . . ), informal employment decision before actually hiring those who signed up. For the selection based on submitted documents, the documents need to be circulated to concerned departments, which requires a lot of time. The problem is that managing of these documents also requires significant effort. Instead of circulating paper documents, electronic files may be sent to a plurality of people in charge of the selection based on submitted documents. Even in such a case, compiling of selection results requires significant effort as it is difficult to manage the selection results in a unified fashion. In addition, each process of notification of information about the seminar and interviews, arrangements for interviews, notification of results such as hiring and non-hiring decisions, contacting with those to be hired for confirming their will to join the company, and the like has to be each performed separately through telephone calls or e-mail to a great number of people who signed up and those who attended interviews, which requires an enormous amount of work. Also because there are a great number of people who signed up, an enormous amount of work is also necessary for managing the database.

The present invention is proposed in view of these problems in the prior art, and its object is to provide a system capable of processing recruitment and job search information efficiently.

### DISCLOSURE OF THE INVENTION

In order to achieve the above mentioned object, the invention provides a recruitment and job search information which is a computer system for processing recruitment and job search information utilizing a communication network such as the Internet, comprising:

recruiting party information storing means for storing recruitment information relative to a plurality of recruiting parties for each recruiting party separately, wherein the stored recruitment information can be viewed from a client device operated by a job seeker accessing to the information via the communication network by specifying a particular recruiting party among the plurality of recruiting parties;

applicant information storing means for storing information concerning job seekers applying for jobs at the recruiting parties (hereafter referred to as applicant information), for each recruiting part separately; and

job seeker registering means for prompting the client device operated by a job seeker accessing by means of the communication network by specifying a particular recruiting party among said plurality of recruiting parties to enter applicant information so as to classify the entered applicant information according to the specified recruiting party and store the information in the applicant information storing means,

wherein the applicant information stored separately for each recruiting party in the applicant information storing means is managed and administered.

Thus, a job seeker desiring to obtain recruitment information may obtain recruitment information by means of a client device via a communication network by specifying a particular recruiting party in which he/she is interested. Then, if the job seeker wishes to get the job, he/she enters application information, such as attribute data concerning himself/herself for registration. The entered applicant information will be classified according to the specified recruiting party and stored in the applicant information storing means. By storing all applicant information from job seekers who have applied for jobs at the recruiting parties subscribing to the system in the applicant information storing means, the administrator managing the applicant information storing means may perform part of the operations of the recruiting parties subscribing to the system on their behalf. As the administrator manages and administers the applicant information storing means storing applicant information from job seekers for a plurality of recruiting parties in a unified way, operations may be streamlined. As a result, costs to be borne by recruiting parties may be greatly reduced. Moreover, as recruitment information may be stored separately for each recruiting party in the recruiting party information storing means, and as contents of the recruitment information may be different for respective recruiting parties, a high degree of flexibility is afforded in managing these contents to have them reflect characters and desires of recruiting parties.

The invention also provides a recruitment and job search information which is a computer system for processing recruitment and job search information utilizing a communication network such as the Internet, comprising:

applicant information storing means for storing information concerning job seekers applying for jobs at said recruiting parties (hereafter referred to as applicant information), for each recruiting part separately;

a recruiting party server having a different URL for each recruiting party on the communication network, capable of being accessed by a client device by means of the communication network, and storing corresponding recruitment information, wherein the recruitment information may be transferred to the client device via the communication network to be displayed on the device, and wherein the client device may be prompted to enter applicant information of the job seekers applying for jobs at the recruiting parties; and

job seeker registering means for storing in the applicant information storing means applicant information transferred via the communication network by means of the client device by relating the information to the recruiting party corresponding to the URL of the recruiting party server accessed at the time of registration,

wherein the applicant information stored in the applicant information storing means and related to the recruiting party is managed and administered.

Thus, a job seeker desiring to obtain recruitment information may obtain recruitment information by means of a client device by accessing a recruiting party server corresponding to a recruiting party of his/her interest. Then, if the job seeker wishes to get the job, he/she enters applicant information as his/her personal data for registration. The entered applicant information will be stored in the applicant information storing means, with maintaining its correspondence to the recruiting party he/she applied. By storing all applicant information from job seekers who have applied for jobs at the recruiting parties subscribing to the system in the applicant information storing means, the administrator managing the applicant information storing means may perform part of the operations of the recruiting parties subscribing to the system on their behalf. As the administrator manages and administers the applicant information storing means, operations maybe streamlined. As a result, costs to be borne by recruiting parties may be greatly reduced. Moreover, as recruitment information may be stored separately for each recruiting party in the recruiting party server having different URL, and as contents of the recruitment information may be different for respective recruiting parties, a high degree of flexibility is afforded in managing these contents to have them reflect characters and desires of recruiting parties.

The recruitment information stored in the recruiting party server may be hyper linked on the communication network with other information concerning the recruiting party not related to recruitment stored on a recruiting party managed server which can be accessed by a client device, and is managed by the recruiting party. To obtain information on a recruiting party, a client device of a job seeker, having accessed the recruiting party managed server, may access the recruiting party server storing recruitment information via a hyperlink from the other information not related to recruitment. This allows the job seekers to view the recruitment information and the other information not related to recruitment without recognizing which server, a recruiting party server or a recruiting party managed server, they are accessing. That is, job seekers would enter their applicant information with the same sense of comfort as before as the system does not make the job seekers notice any difference from the previous scheme in which applicant information is to be entered through a homepage provided on a recruiting party managed server. This may encourage job seekers to enter their applicant information.

The URL of the recruiting party server may contain a string that represents the name of the recruiting party. This makes job seekers believe that the recruiting party server is managed by the recruiting party in the same way as the recruiting party managed server managed by the recruiting party, so that they would not notice the difference between the recruiting party managed server and the recruiting party server.

Preferably, the job seeker registering means may store applicant information in the applicant information storing means for each recruiting party separately based on recruiting party data attached to the applicant information and indicating which recruiting party is concerned with the application from the recruiting party. In this manner, a recruiting party at which a job seeker desires to find a job may be identified, and entered applicant information may be classified for respective recruiting parties.

In addition, replying means may be provided such that once the job seeker registering means stores applicant information in the applicant information storing means, email addresses contained in the applicant information may be extracted to create and send back reply mail addressed to the email addresses. By sending replies to individual applicants applying for jobs at all the recruiting parties subscribing to the system uniformly, costs to be borne by the recruiting parties may be greatly reduced as a result.

The applicant information stored separately for each recruiting party in the applicant information storing means may be made accessible to a recruiting party device operated by a corresponding recruiting party by means of the communication network. This allows the recruiting party to exercise self-management by performing such operations as viewing, searching, and data processing of applicant information from applicants applying for jobs at the company by means of the communication network. That is, the recruiting party is allowed to perform operations comfortably as they do with a database they constructed by themselves. Therefore, as the administrator manages and administers the applicant information storing means in a unified way as described above, operations may be streamlined. Also, whether to resort to management by the administrator or to self-management by the recruiting parties may be decided based on working efficiency or other factors.

In addition to the applicant information of applicants entered by the applicants, the applicant information storing means may store status information indicating a status of job seekers in a hiring process. By also storing the status information in the applicant information storing means, the hiring process following the registration of job seekers may be run based on the status information. As the status information is stored in the applicant information storing means, the status of applicants may be managed in a unified way, for example, a quick reply is possible when a registered job seeker inquires about his/her situation since then.

The status information may include evaluation information indicating an evaluation of the job seeker made by the recruiting party, or it may include notification information indicating whether or not contact has been made to a corresponding job seeker. Moreover, it may also include hiring result information indicating whether or not to hire the applicant. By storing evaluation information, notification information, and hiring result information in the applicant information storing means, they may be managed in a unified way, thus reducing the work for the recruiting party.

In addition, notification mail creating means may be provided such that email addresses may be extracted from the applicant information from applicants to create notification mail addressed to these addresses for communicating about interviews, a seminar, or the like. This may save the person in charge the work of creating mail for communication, thereby greatly reducing costs to be borne by the recruiting party.

The status information may be made accessible to a recruiting party device operated by a corresponding recruiting party by means of the communication network, and different access rights may be provided depending on which member of the recruiting party is operating the recruiting party device. The recruiting party is also allowed to exercise self-management by performing such operations as viewing, searching, and data processing of applicant information from applicants applying for jobs at the company by means of the communication network, however, even in this case, unauthorized processing of the information may be prevented by providing different access rights according to respective members of the recruiting party.

### BRIEF DESCRIPTION OF THE DRAWINGS

FIG. 1 is a block diagram showing a construction of an embodiment of the recruitment and job search information processing system according to the invention;

FIG. 2 is a block diagram showing a construction of a recruiting party server;

FIG. 3 shows an exemplary view of job opening announcement;

FIG. 4 shows an exemplary view of job position information;

FIG. 5 shows an exemplary view of registration information;

FIG. 6 is a block diagram showing a construction of a management server;

FIG. 7 is a functional block diagram of one embodiment of a recruitment and job search information processing system according to the invention;

FIG. 8 shows an example of reply mail;

FIG. 9 is a flow chart describing processes to be performed on entered applicant information;

FIG. 10(a) shows exemplary data of applicant information to be transferred from a job seeker;

FIG. 10(b) shows exemplary data of status information;

FIG. 11 is a block diagram showing a construction of another embodiment of the management server;

FIG. 12 is a functional block diagram of another embodiment of a recruitment and job search information processing system according to the invention;

FIG. 13(a) is an exemplary registration screen view of applicant information for newly graduated job seekers;

FIG. 13(b) shows an exemplary screen view of seminar registration homepage;

FIG. 14 is a flow chart describing processes that subsequently follow registration by newly graduated job seekers;

FIG. 15 shows an exemplary screen view for an applicant search by a hiring process unit;

FIG. 16 shows an exemplary screen view resulting from the search in FIG. 15;

FIG. 17 is an exemplary view of applicant information and status information about an applicant;

FIG. 18 is an exemplary view that follows that in FIG. 17;

FIG. 19 is an exemplary screen view for a search to create a mail by the hiring process unit;

FIG. 20 is an exemplary screen view resulting from the search in FIG. 19;

FIG. 21 shows an example of notification mail;

FIG. 22 is a block diagram showing a construction of yet another exemplary recruitment and job search information processing system according to the invention;

FIG. 23 is a block diagram showing a construction of still another exemplary recruitment and job search information processing system according to the invention;

FIG. 24 is a block diagram showing a construction of a further another exemplary recruitment and job search information processing system according to the invention; and

FIG. 25 is a block diagram showing a construction of a still further another exemplary recruitment and job search information processing system according to the invention.

### BEST MODE FOR CARRYING OUT THE INVENTION

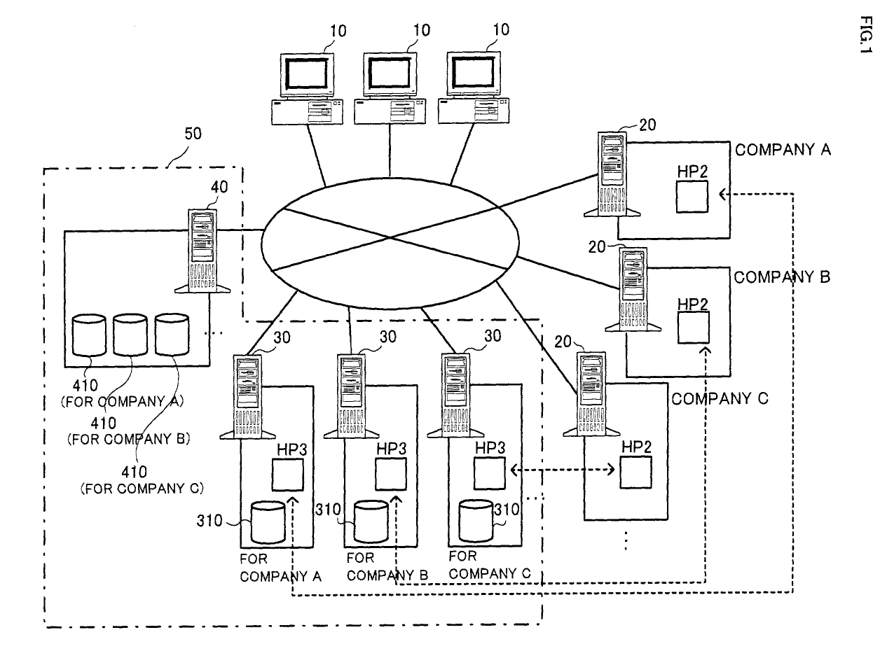

Embodiments of the present invention will be described below with reference to the drawings. FIG. 1 shows a first embodiment of an overall construction including a recruitment and job search information processing system. In this FIG. 1, reference numerals 10, 10 . . . denote client computers capable of establishing connection to the Internet through a telephone line and a provider, and they may be operated by job seekers when appropriate. Reference numerals 20, 20 . . . denotes recruiting party managed servers that are either owned by companies recruiting new employees (companies A, B, and C) subscribing to this system as a recruiting party or otherwise controlled by these companies, and these servers are continuously connected to the Internet. Reference numeral 50 denotes a recruitment and job search information processing system according to the invention, comprising a recruiting party server 30 and a management server 40. Recruiting party servers 30, 30 . . . are also continuously connected to the Internet, and as a rule a plurality of the number of the servers 30, 30 . . . are provided in accordance with the number of companies recruiting new employees (companies A, B, C) subscribing to the system. Reference numeral 40 denotes a information management server continuously connected to the Internet. The recruiting party servers 30 and the management sever 40 are essentially managed by an administrator managing the system 50. Such tasks as configuration of these servers 30 and 40, as well as creation, modification, and deletion of files to be stored are mainly performed by the administrator.

On the recruiting party managed server 20, a homepage HP2 of a company recruiting new employees that corresponds to the server 20 is provided such that the homepage HP2 may be viewed with a browser on a client computer 10 of a job seeker by specifying the URL for the homepage HP2 at the client computer 10 and receiving information to be displayed. The homepage HP2 contains information not related to recruitment such as typical introduction of the company and information about company's goods and products, and also contains buttons such as the one named “hiring information” (or “recruitment information”). Through a hyperlink, this button leads to the URL for a hiring homepage HP3 provided on a recruiting party server 30 corresponding to the company recruiting new employees. When a job seeker clicks on this button with a mouse etc., information for displaying hiring information will be sent from the recruiting party server 30. Then, the recruiting party server 30 takes the place of the recruiting party managed server 20 as the server from which information is sent, however, this change will not be particularly noticed by the job seeker who only perceives it as ordinary switching between different pages within the same Web page. Preferably, the recruiting party server 30 may have different URLs on the Internet for respective companies recruiting new employees, the URLs containing strings representing names of these companies so as to make look natural the linking from the homepage HP2 provided on the recruiting party managed server 20.

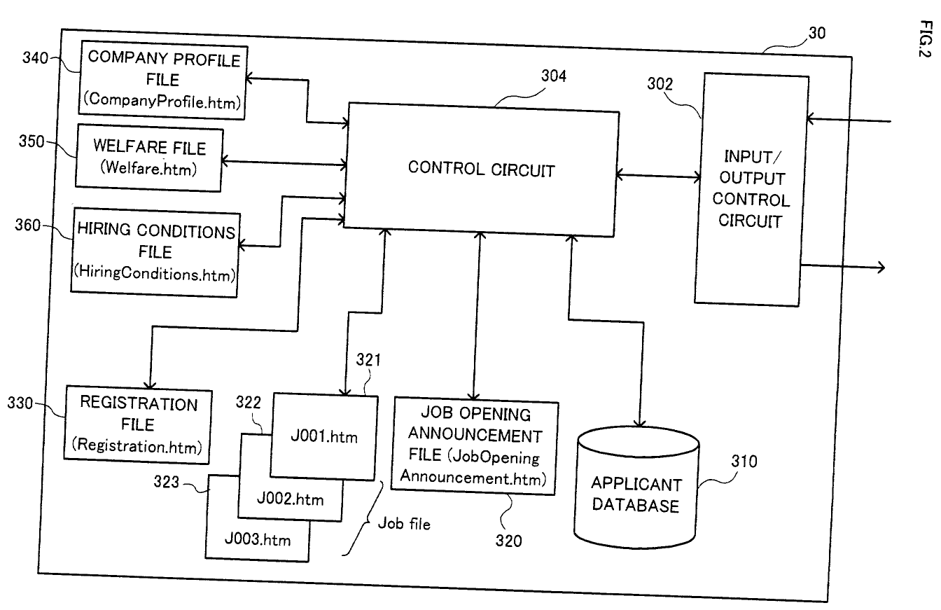

As shown in FIG. 2, the recruiting party server 30 comprises an input/output control circuit 302 for controlling input/output of data from/to a client computer 10 etc. connected via the Internet, and a control circuit 304 having a CPU, ROM, RAM and the like that transfers data, performs a computation, temporarily stores data, and stores main programs. Further stored in the storage device of the recruiting server 30 are an applicant database 310 storing information about job seekers desiring to find jobs at respective companies recruiting new employees, a job opening announcement file (JobOpeningAnnouncement.htm) 320 to which job opening announcement information is written, and a registration file (Registration.htm) 330 to which registration screen view information is written.

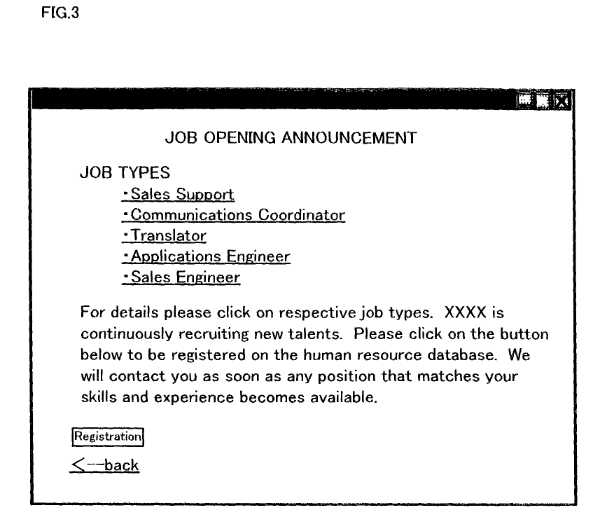

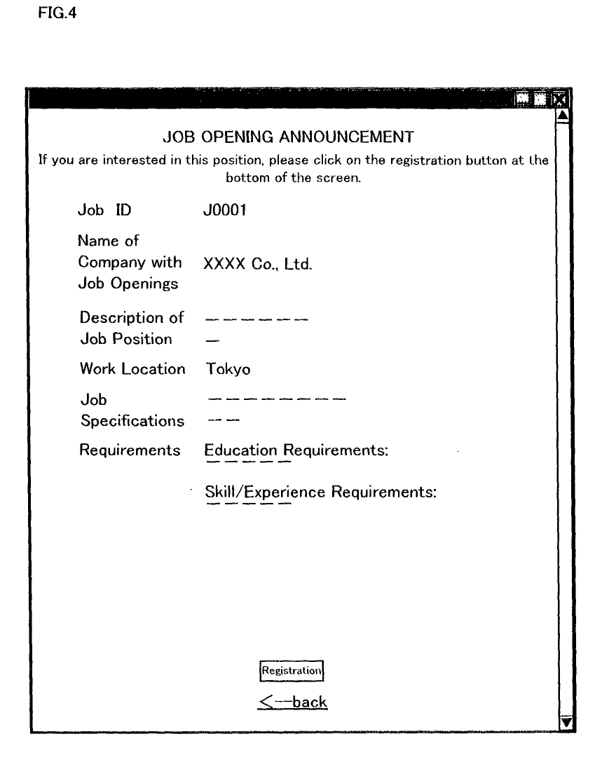

The job opening announcement information written to the job opening announcement file (JobOpeningAnnouncement.htm) 320 concerns job positions for which the company recruiting new employees corresponding to the recruiting party server 30 is trying to find a person. Furthermore, job specifications are respectively provided for detailed information of respective job positions, and a job ID, a duty, a job place, job specifications, required conditions and the like, for example, are written to each of the files 321, 322 . . . FIG. 3 shows an exemplary view of job opening announcement information displayed with a browser. FIG. 4 shows an exemplary view of job position information displayed with a browser.

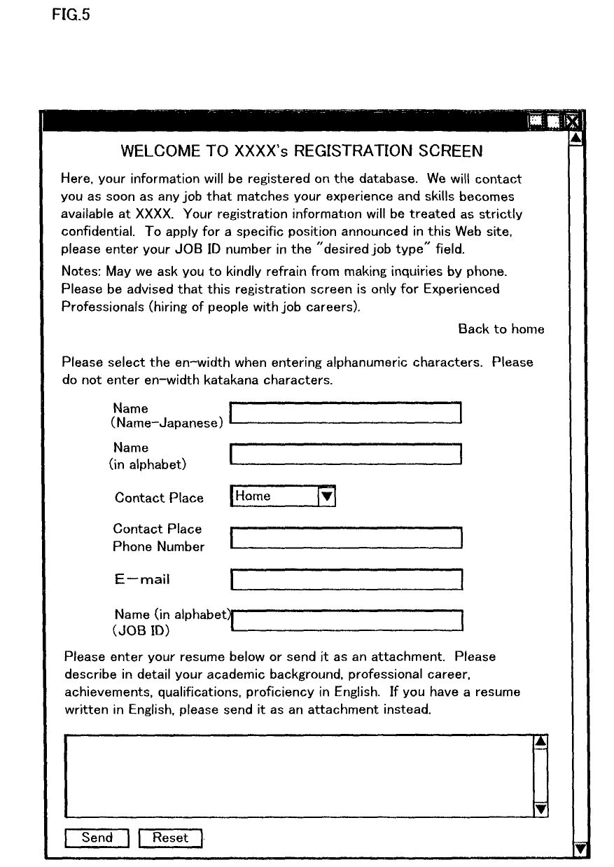

Written to the registration file 330 is a form to prompt entering of the data (hereafter applicant information) that the company recruiting new employees corresponding to the recruiting party server 30 desires to obtain from job seekers. Specifically, applicant information includes name, name (in alphabet), contact place, desired job postion (job ID), email address, resume, and the like. FIG. 5 shows an exemplary screen view to prompt entering of such data.

Types of files to be contained in the recruiting server 30 and contents to be written to the files may be decided according to the desires of respective companies recruiting new employees without any constraints. That is, data items to be written to the job opening announcement file 320, registration file 330 and the like described above, as well as image files to be embedded in these files are different for each of a plurality of recruiting party servers 30, and the layouts shown in FIGS. 3 and 5 are merely examples. Each company recruiting new employees may advertise its own characters and uniqueness to appeal to the job seekers. Only the administrator has the access right to edit the job opening announcement file 320, job specification files 321, 322 . . . , registration files 330 and the like, performing edits upon a request of or based on communications from the companies recruiting new employees. For example, as the job opening announcement and job positions are changed at any time, the administrator modifies the job opening announcement file 320, job specifications files 321, 322 . . . upon receiving communication from companies recruiting new employees. As the administrator manages and maintains the job opening announcement files 320, job specifications files 321, 322 . . . , registration files 330 over a plurality of companies recruiting new employees in a unified way, operations may be streamlined and costs to be borne by respective companies recruiting new employees may be reduced. Moreover, with regard to public announcements and advertisements for spreading the knowledge of URLs for homepages HP3, joint activities may be organized to publicly announce and advertise URLs for homepages HP3 that correspond to a plurality of companies recruiting new employees so as to enhance efficiency and reduce the costs to be borne by respective companies recruiting new employees.

Among the companies recruiting new employees subscribing to this system, there may be companies that do not desire to exist a recruiting party server 30 corresponding to the recruiting party managed server 20. In such a case, the recruiting party managed server 20 takes the place of the recruiting party server 30.

Conversely, among the companies recruiting new employees subscribing to this system, there may be companies that either do not have recruiting party managed servers 20 on which their company's homepages HP2 are provided or, even when they have such servers, do not provide hiring or recruitment sections in the home pages HP2. In such a case, job seekers will directly browse a homepage HP3 on a recruiting party server 30 of a corresponding company recruiting new employees. Even in this case, by including the names of companies recruiting new employees in the URLs of the recruiting party servers 30, it is possible to lead job seekers to browse homepages HP 3 on the recruiting party servers 30 without making them notice that the pages are not on the recruiting party managed servers 20.

On the recruiting party server 30, a company profile file (CompanyProfile.htm) 340 to which a company profile is written, a welfare file (Welfare.htm) 350 to which welfare descriptions are written, hiring conditions file (HiringConditions.htm) 360 to which hiring conditions information is written and the like are also provided as necessary. However, these files 340 to 360 maybe present on the recruiting party managed server 20 rather than on the recruiting party server 30, or hyperlinks may be set in homepages between the two servers 20 and 30. The difference between whether these files 340 to 360 are provided on the recruiting party server 30 or on the recruiting partymanaged server 20 manifests itself only as the difference between whether it is the administrator who performs such tasks as creation, modification, and deletion of the files 340 to 360 or it is the companies recruiting new employees that do so themselves. Thus, the different is not at all noticed by job seekers.

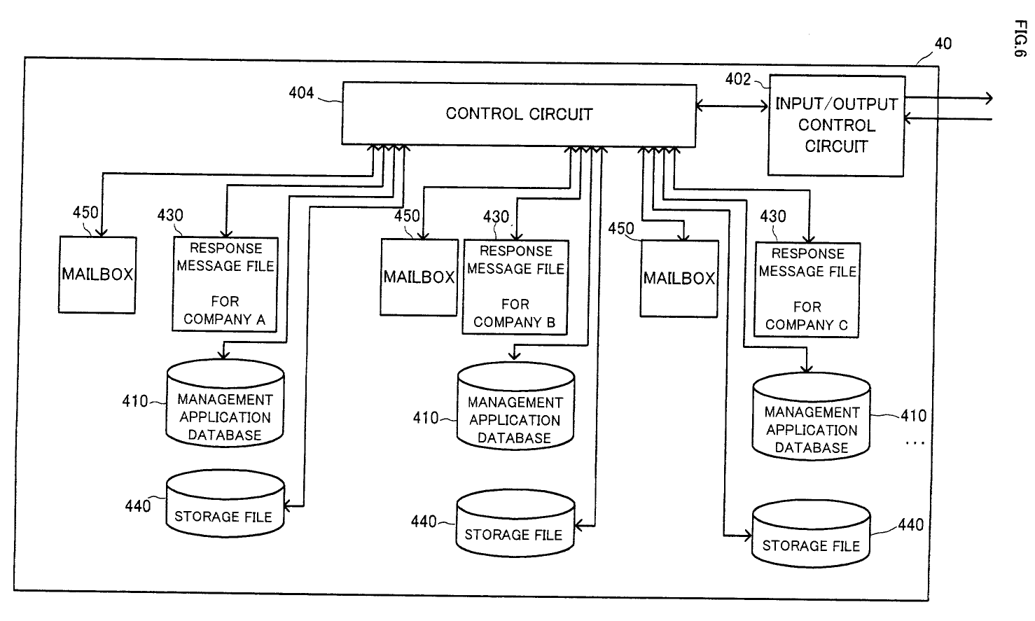

Similar to the recruiting party server 30 and as shown in FIG. 6, the management server 40 comprises an input/output control circuit 402 for controlling input/output of data from/to a client computer 10 etc. connected via the Internet, and a control circuit 404 having a CPU, ROM, RAM and the like that transfers data, performs a computation, temporarily stores data, and stores main programs.

Further stored in the storage device of the management server 40 are a plurality of management applicant databases 410 provided for respective companies recruiting new employees, a plurality of response message files 430, storage files 440, and mailboxes 450 for receiving email, respectively for provided for respective companies recruiting new employees.

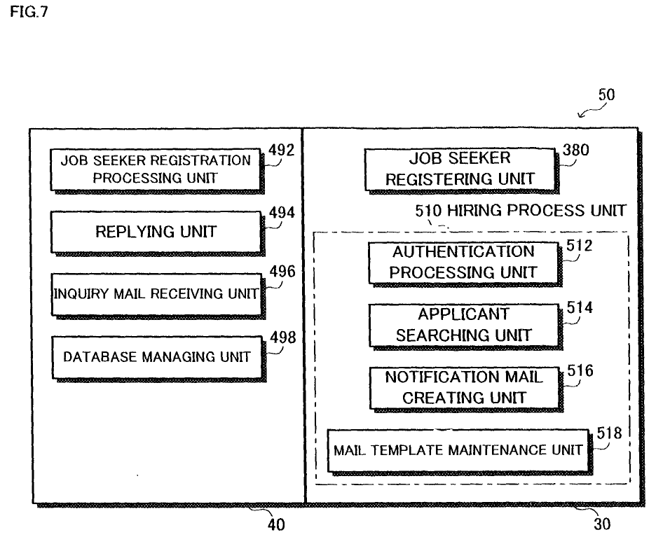

FIG. 7 is a functional block diagram showing processes to be performed in the control units of the recruiting party server 30 and management server 40 in terms of respective functions. The recruiting party server 30 comprises a hiring process unit 510 as described below, and the management server 40 comprises a job seekers registration processing unit 492 for processing registration of applicant information from job seekers, a replying unit 494, an inquiry mail receiving unit 496, and a database managing unit 498. It is not absolutely necessary that these functions be within the servers 30 and 40 shown, and they may be located in other servers or performed by control units of other devices provided in the system 50.

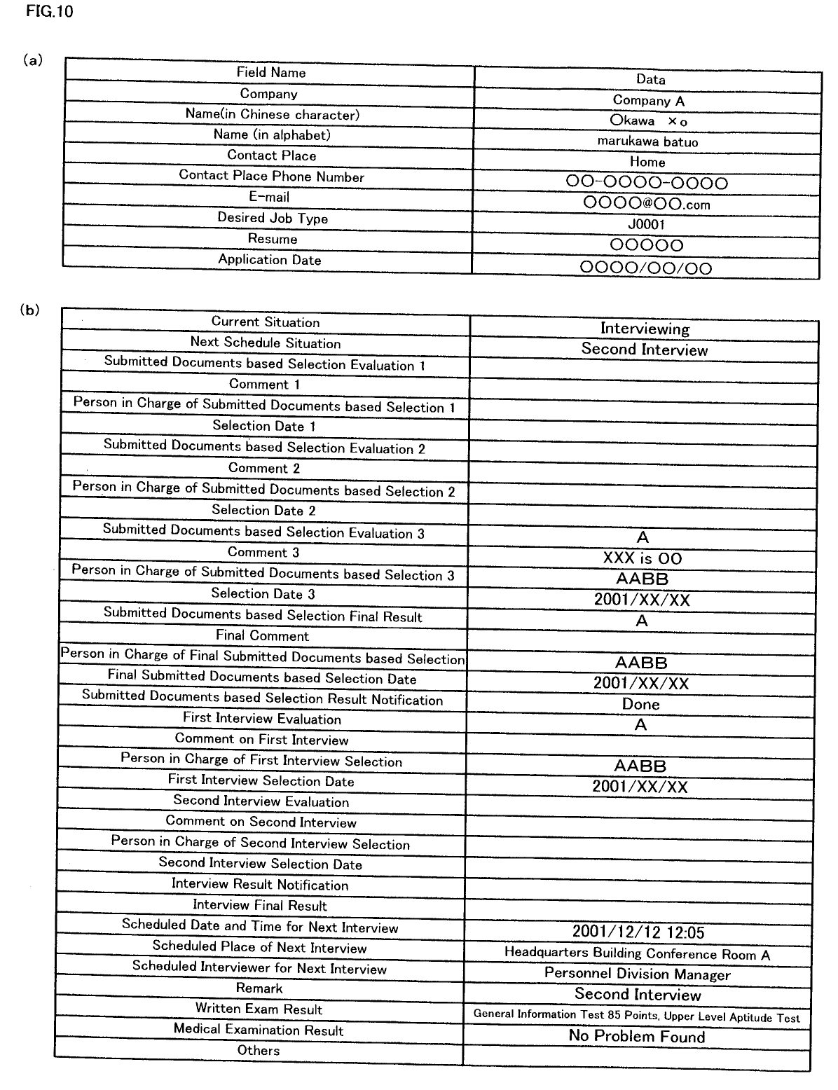

Now, processing to be performed when a job seeker accesses the system 50 via the Internet will be described below. By means of a browser on his/her client computer 10, the job seeker may specify the URL of the recruiting party managed server 20 of a company he/she is interested in to view a homepage HP2, and then view a homepage HP 3 through a hyperlink from the homepage HP2, or he/she may specify the URL of a recruiting party server 30 corresponding to the company to view the homepage HP3 directly. After viewing job opening announcement information (FIG. 3), job position information (FIG. 4) sent from the recruiting party server 30 or recruiting party managed server 20, if the job seeker desires to get a job in the company recruiting new employees, he/she clicks on the “registration” button. This brings up a registration page specified in the registration file 330 from the recruiting party server 30 on the screen. With the browser, the job seeker enters his/her response to each inquiry. When the job seeker clicks on the “send” button having finished entering information, the registration information will be transferred from the client computer 10 to the management server 40 by a script such as CGI or PHP constituting a job seekers registration processing unit 492 specified in the registration file 330. At this time, company data for identifying a corresponding company recruiting new employees will be transferred along with the applicant information. FIG. 10(a) shows exemplary data of applicant information to be transferred. The data being transferred mainly contains attribute data for the applicant, and the name of a corresponding company recruiting new employees is also added to the data with the field name=“company.”

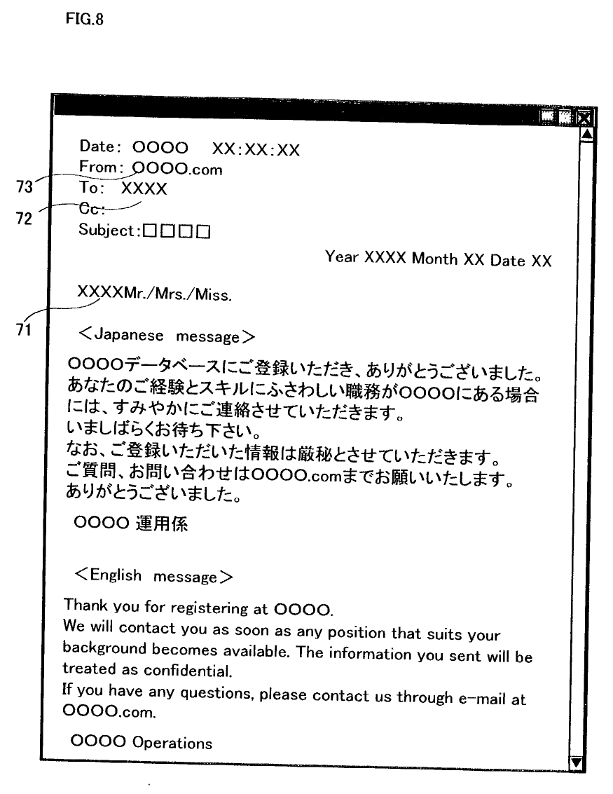

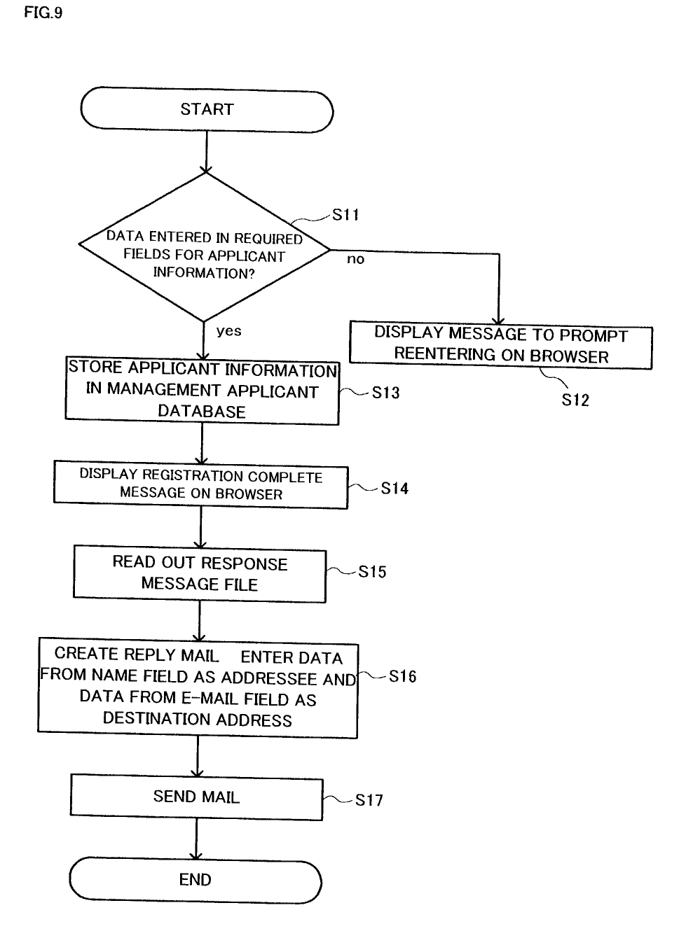

Once the applicant information from the job seeker is transferred, another program constituting the job seekers registration processing unit 492 will be activated. FIG. 9 shows a flow chart for this program. With respect to the applicant information from the job seeker, whether or not mandatory fields among the fields shown in FIG. 10 have data that has been entered is determined (Step S11 in FIG. 9). For example, with respect to all the fields in FIG. 10 other than that for a contact telephone number (name, name (in alphabet), email, desired job type, resume), whether they have any blank instead of data is determined. If any one of the required fields has a blank, a message to prompt reentering of data is sent to the client computer 10 to be displayed by the browser on the computer 10 (Step S12 in FIG. 9). If there is no madetory field that has a blank, the applicant information will be sorted according to the data values in the “company field” and stored in the management applicant database 410 of the corresponding company recruiting new employees (Step S13 in FIG. 9). Then, a message for the completion of registration will be sent to the client computer 10 to be displayed by the browser on the computer 10 (Step S14 in FIG. 9). Then, the replying unit 494 is activated to read out the company data from the applicant information to read out a reply mail template described in the response message file 430 corresponding to the company data provided on the management server 40 (Step S15 in FIG. 9), response messages files 430 being provided for respective companies. Then, the replying unit 494 creates reply mail automatically (Step S16 in FIG. 9). In doing so, it enters the name data of the “name” field from the applicant information as the addressee (reference numeral 71 in FIG. 8) in the mail document to be sent, and enters the email address data from the “email” field from the applicant information as the destination address (reference numeral 72 in FIG. 8) (Step S16 in FIG. 9), and sends the mail (Step S17 in FIG. 9). The source of this reply mail is configured to be the recruiting party server 30 (reference numeral 73 in FIG. 8) rather than the management server 40. FIG. 8 shows an exemplary reply mail. Companies recruiting new employees may give originality to the descriptive content of this mail. However, except for the difference of sources, basic contents are mostly the same such that response message files 430 for respective companies recruiting new employees may be created based on a basic template in an efficient manner.

The administrator may check the transferred applicant information to separate applicants suitable for respective companies recruiting new employees or to filter out those who are unsuitable. For example, if there is a new applicant who selected a desired job type that matches a job position for which the company is currently recruiting a person, then mail is created for the company recruiting new employees for notification. In contrast, if the applicant does not satisfy conditions that are considered absolutely necessary by the company recruiting new employees, then no effort will be made to notify the company. For the companies recruiting new employees, as the filtering by the administrator selects out inappropriate applicants, suitable persons may be found efficiently. Copies of the registration information stored in the management applicant database 410 will be made by the database managing unit 489 to be stored in the applicant database 310 provided on the recruiting party server 30. A person in charge of recruitment at the company recruiting new employees may access the applicant database 310 on this recruiting party server 30 via the Internet, and view and search the contents utilizing functions of a hiring process unit 510 described below. Therefore, by checking the applicant database 310, the person in charge may view detailed information for all the applicants, including information for those applicants who have been filtered out by the administrator.

For a plurality of management applicant database 410, the administrator manages and administers data by means of programs constituting the database managing unit 498 of the management server 40 in a unified and centralized fashion. For example, when data becomes old, that is after a predetermined number of years have passed since the day the data was first registered, it may be appropriately moved from the management application database 410 to the storage file 440 automatically, thus the management applicant database 410 and the applicant database 310 being arranged to store only relatively new data. Since such processing may be performed on all the management applicant databases 410 at a time, processing may be streamlined, and as a result, costs to be borne by respective companies recruiting new employees may be reduced.

The above described system has an advantage in that the administrator may communicate with job seekers on behalf of the people in charge of recruitment of the companies recruiting new employees. One example is given by the reply mail described above that is sent automatically to the registered job seekers. Another example is given by the fact that the mailbox 450 provides a storage location for inquiry mail from people who viewed the homepage HP3 or HP2. Email from job seekers or the like will be stored in the mailbox 450 by the inquiry mail receiving unit 469. For the same question asked by different people or frequently asked questions received through inquiry mail, the administrator may provide answers on behalf of the people in charge of the companies recruiting new employees, saving them effort to directly providing answers. In this manner, loads placed on the companies recruiting new employees may be reduced, thereby reducing costs for recruitment.

Moreover, the administrator may contact suitable applicants found through the filtering of information in the management applicant database 410 by the administrator or suitable applicants the companies recruiting new employees have found on their own by viewing information in the applicant database 310, and make schedule arrangements for a seminar, interviews, and the like and communicate hiring or non-hiring decisions to the applicants on behalf of the people in charge of recruitment. This may be easily achieved based on the fact that applicant information for all the applicants is stored in the management applicant database 410 or the applicant database 310 provided on the administrator's side. Thus, loads placed on the companies recruiting new employees may be reduced, thereby reducing costs for recruitment.

Nevertheless, the applicant database 310 managed by the administrator in this manner may be accessed from a recruiting party computer (recruiting party device) operated by a person in charge of recruitment of a company recruiting new employees via the Internet to run the hiring process by means of functions of the hiring process unit 510 in a recruiting party server 30. Now, functions of this hiring process unit 510 will be described in detail.

In particular, as shown in FIG. 7, the hiring process unit 510 comprises an authentication processing unit 512, an applicant searching unit 514, a notification mail creating unit 516, and a mail template maintenance unit 518.

The authentication processing unit 512 has a function of verifying whether or not the use of the hiring process unit 510 may be allowed. It compares a user name and a password with data stored in an authentication database not shown in the drawings and performs processing to determine whether or not to authorize access based on the comparison result. Basically, other than the administrator, authorization for access to a corresponding applicant database 310 is given only to people belonging to a company recruiting new employees corresponding to each applicant database 310. In stead of giving authorization to all people belonging to the company recruiting new employees, it is also possible to limit the access authorization to people in charge of a specific department, for example, a recruitment department or a related department, or to executives above certain ranks.

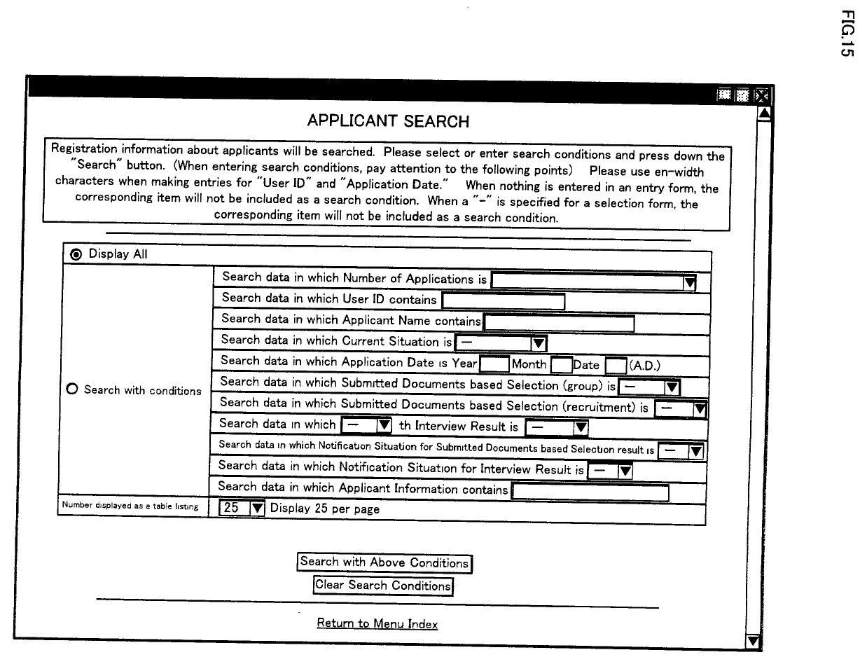

The applicant searching unit 514 provides a function of extracting those who satisfy predetermined conditions from among the applicants registered on the applicant database 310. Search may be performed according to any conditions as shown in the exemplary screen of FIG. 15. Any conditions may be set for respective companies recruiting new employees, and the number of conditions may be increased or decreased.

The notification mail creating unit 516 provides a function to create notification mail to be sent to email addresses of applicants.

The mail template maintenance unit 518 provides a function to add, edit, and delete templates for email to be sent to applicants.

In the applicant database 310, in addition to applicant information mainly representing attribute data for the applicants that has been entered as the applicants sign up as shown in FIG. 10(a), status information corresponding to the applicant information as shown in FIG. 10(b) is stored. As status information, by way of example, current situation information representing a current situation such as selecting based on submitted documents, interviewing, pending, informal employment decision given, failed, and decline as well as evaluation information representing results such as evaluation results of selection based on submitted documents, interviewing, written exams, and a medical examination result, recruitment result information representing final results of whether or not to hire the applicants, notification information indicating whether or not notification has been made for each result or the like, and a reserve situation representing reservations for the next (proximate) schedule may be exemplified.

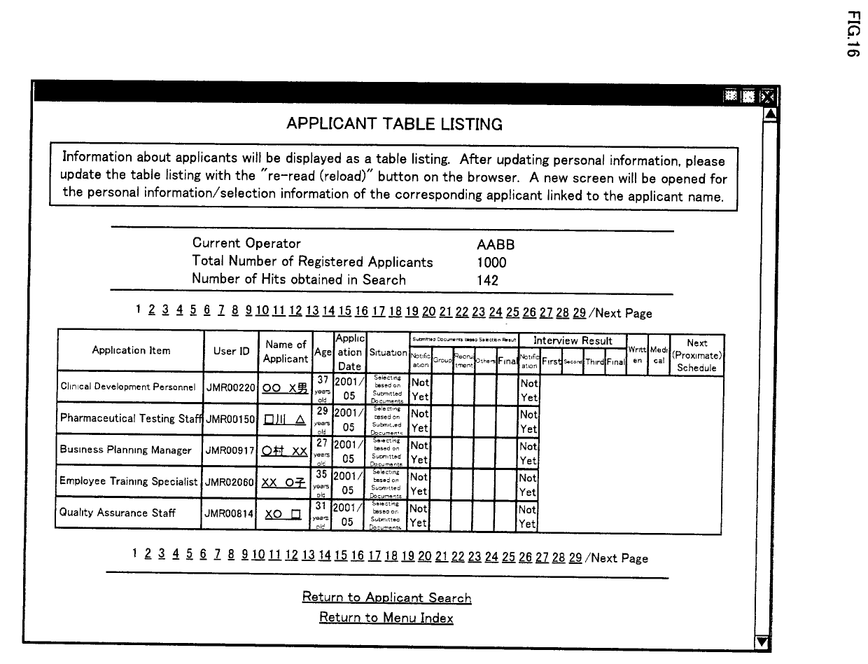

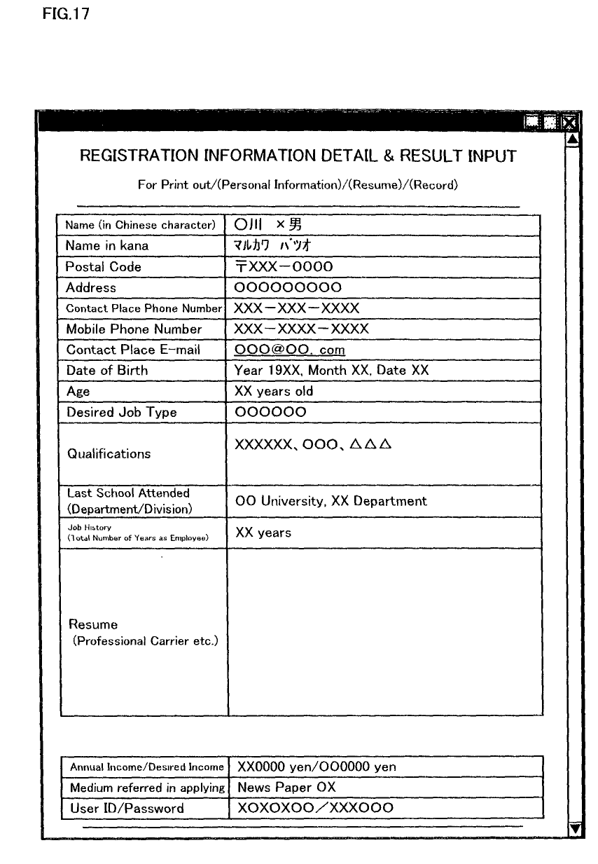

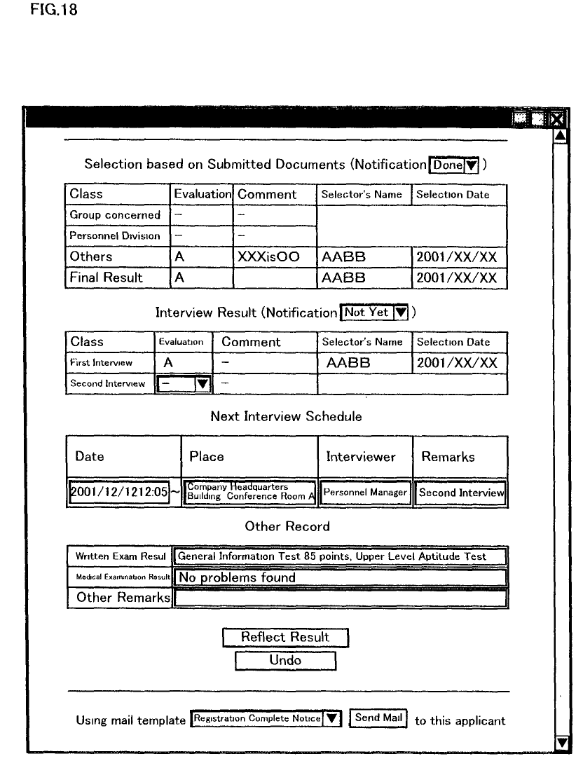

Though a hiring process may be considered to have various embodiments depending on respective companies recruiting new employees, in the following, processing by the hiring process unit 510 will be described in detail according to a basic hiring process. First, selection based on submitted documents will be carried out with respect to newly registered applicants. The selection based on submitted documents is carried out by that a person in charge of selection-based-on-submitted documents enters evaluation information into the submitted documents-based-selection-evaluation-field in the status information for each applicant found in the applicant database 310. There may be more than one person in charge of selection-based-on-submitted-documents, and in case there are multiple persons in charge, a corresponding number of submitted-documents-based-selection-evaluation-fields will be provided. The person in charge of selection-based-on-submitted-documents searches for applicants not yet to be subjected to selection-based-on-submitted-documents with the applicant searching unit 514 to have a screen view of an applicants table displayed as shown in FIG. 16, and enters evaluation in the fields for submitted-documents-based-evaluation displayed there. As applicant information and status information will be displayed as tables as shown in FIGS. 17 and 18 by clicking on each applicant's name, the person in charge may make his/her evaluation inspecting the applicant information. Preferably, when a submitted-documents-based-selection-evaluation is entered, based on the user name at the time of access, the system may determine whether or not the person has a legitimate access right to enter the submitted-documents-based-selection-evaluation.

Once all the persons in charge of selection-based-on-submitted-documents finishes entering their evaluations, final results for the selection-based-on-submitted-documents will be entered. Here again, the access right to enter the final results may be given exclusively to a specific person, for example to a specific person among the people in charge of recruitment. Until final results are delivered, the value in the current situation field indicates “selecting based on submitted documents.”

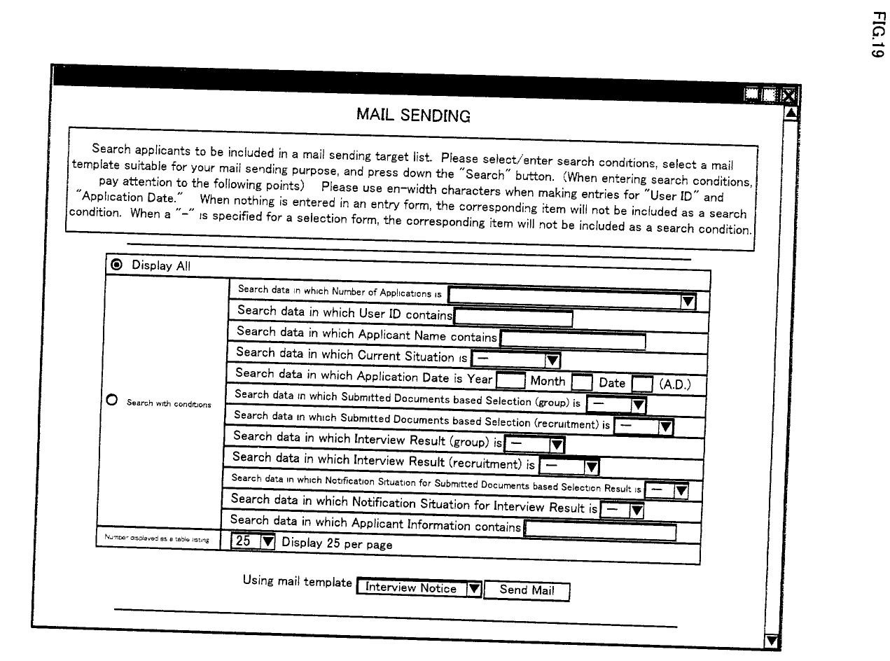

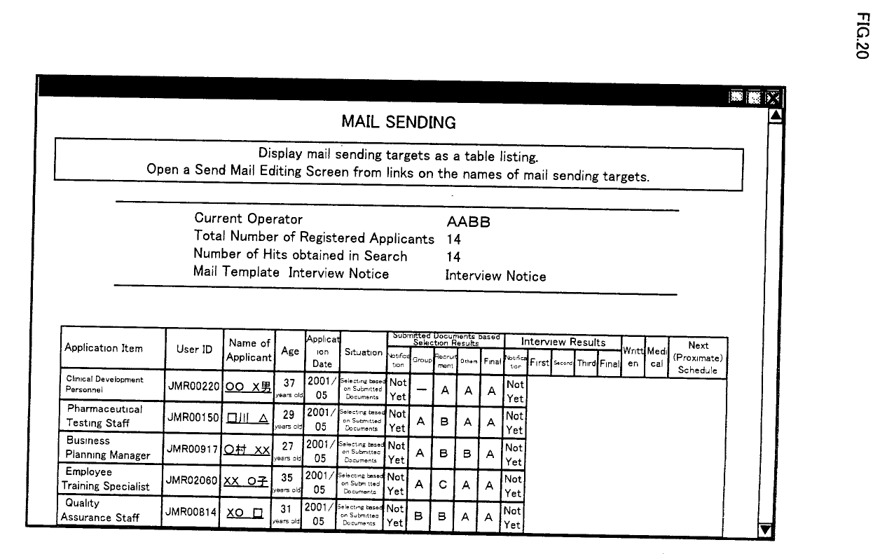

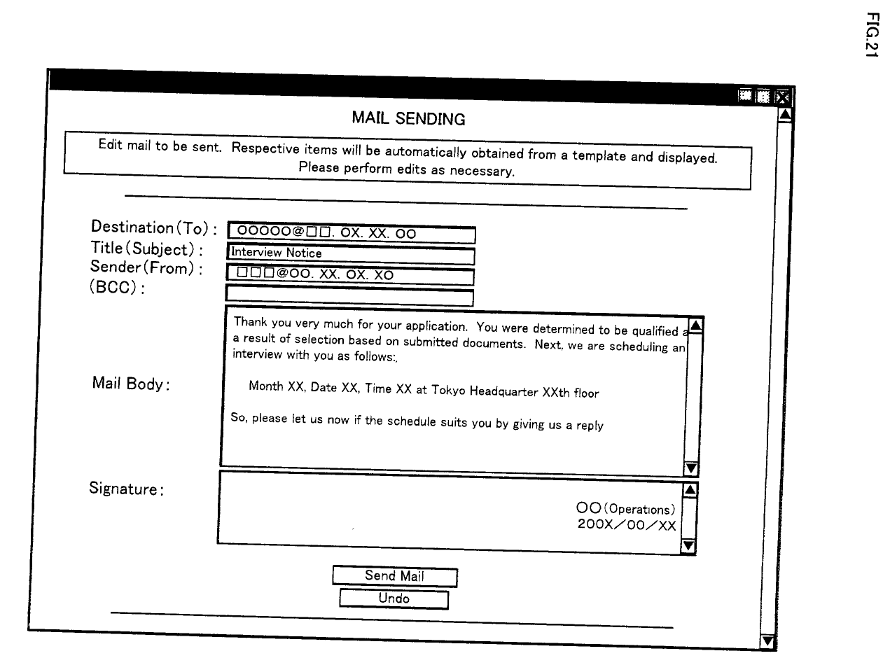

Once final results of the selection-based-on-submitted-documents are determined, they need to be communicated to the applicants. The processing for notification is performed by means of the notification mail creating unit 516. As shown in FIG. 19, the notification mail creating unit 516 has a search function similar to the one provided by the applicants searching unit 514. Here, the value of the submitted-documents-based-selection-results-notification-field indicates “not-yet” such that a table listing of those not yet to be notified will be displayed (FIG. 20) by extracting submitted-documents-based-selection-final-results that satisfies the condition that they indicate a certain value. At the same time, the name of a template to be used for mail maybe selected. By conveniently selecting a name among those displayed in the table, an email address is read out from applicant information of the applicant for a destination address, and the main body is created based on the selected template name according to the mail creating function of the notification mail creating unit 516 (FIG. 21). Moreover, the person in charge may modify the content of the mail. Thus, notification mail is created automatically for the most part, and the person in charge may complete the notification work by merely clicking on the send mail button on the screen. For those applicants who “passed” as final results of the selection-based-on-submitted-documents, mail for notifying the schedule of the next interview will be sent based on a template for notifying about interviews, and for those applicant who “failed,” mail for notifying about the failure will be sent based on a template for notifying about failure. However, this is not the only function provided by the notification mail creating unit 516. For example, if “passed” is entered as the final results for the selection-based-on-submitted-documents-final-result, the notification mail creating unit 516 will be automatically activated to create and send mail using the template for notifying about interviews, and if “failed” is entered as the final results for the selection-based-on-submitted-documents-final-result, the notification mail creating unit 516 will be automatically activated to create and send mail using the template for notifying about failure and using the template for notifying about interviews, thus making the above described processing completely automatic.

For interviews with those applicants who passed, if there are a plurality of possible schedules, a URL for choosing from the possible schedules may be described in the mail for notifying about an interview to allow the applicant to select and enter a date or the like with a browser at the URL. That is, the applicant who received email selects a schedule by choosing a convenient schedule on an registration screen at the site specified by the URL, and by making entries for registration items other than the interview schedule displayed on the screen using a client computer 10. Here, when allowing a plurality of applicants to choose desired schedules from a plurality of overlapping possible schedules, if the number of applicants signing up for a certain schedule reaches the full quota, preferably, the schedule may be eliminated from the choices on the registration screen. The registered schedule data will automatically be entered in the plan situation field of the corresponding applicant within the applicant database 310. The person in charge may have the applicants enrolled for a certain schedule displayed as a table listing.

Then, after conducting interviews, the person in charge enters interview evaluations into the displayed screen of FIG. 16 or 18. The number of times interviews will be conducted vary depending on the company recruiting new employees or the applicant. Therefore, preferably, a field for an interview in the displayed screen of FIGS. 16 and 18 may be added each time an interview evaluation is entered until the final result of interviews is entered. To this end, preferably, a large number of fields for interviews may be provided on the applicant database so as to display up to the fields for the interview whose ordinal number is equal to or less than the number of interviews already conducted +1, or alternatively, the field for the n+1th interview may be automatically created and added each time an interview evaluation is entered, adding 1 to the ordinal number of this interview.

Communicating of an interview result is similar to the notification of a result of selection-based-on-submitted-documents. A notification about the next interview may be carried out by means of the notification mail creating unit 516. In this manner, until a final interview result is entered after several interviews, the processes of notifying about the next interview, entering an interview evaluation, and communicating an interview evaluation are repeated. At the same time, every time each processing is performed, the current situation field will be automatically rewritten.

Moreover, if a written exam and a medical examination are performed in addition to the interviews described above, their results and the like will be entered by the person in charge from the displayed screen shown in FIG. 16 or 18.

When a final result (= often this is the same as the final interview evaluation) to hire or reject the applicant is determined, the result needs to be notified. This maybe also carried out by creating and sending mail by means of the notification mail creating unit 516.

Furthermore, when an informal decision to hire the applicant is given, there will be a need for confirming the intention of the applicant to join the company or to decline the offer. Such notification may be also performed by means of the notification mail creating unit 516.

As described above, by performing processing by means of the hiring processing unit 510 of the recruiting and job search processing system 50, the following advantages may be achieved.

1) While the hiring process may vary depending on respective companies recruiting new employees, often there is a common basic portion. Therefore, based on the basic process, a hiring process unit may be constructed for each company recruiting new employees. In this way, compared with the case where each company recruiting new employees constructs a hiring system on its own, the cost may be reduced. Also the cost required for the maintenance of the hiring process unit 510 may also be reduced.

2) Moreover, in the case of processing such as entering of status information into the applicant database 310 was performed by a person in charge of recruitment and the like of the company recruiting new employees, the processing may be delegated to the administrator easily. Conversely, the company recruiting new employees may easily take back the operations that have been delegated to the administrator. Thus, such operational changes may be dealt with in a flexible manner.

3) When there is an inquiry from an applicant about his/her current situation, data concerning the applicant may be extracted from the applicant database by means of the applicant searching unit 514 so as to check the current status, the next schedule and the like from the status information of the applicant for informing the applicant of them.

4) Also when there are a large number of people in charge of selection-based-on-submitted-documents, as there is actually no need to circulate documents and as submitted-documents-based-evaluations are managed in the applicant database 310 in a unified way, the selection-based-on submitted-documents may be performed rapidly without suffering from mix-up of data and without much effort.

5) Also notification to an applicant such as notification of an interview schedule or various results may be performed rapidly without much effort.

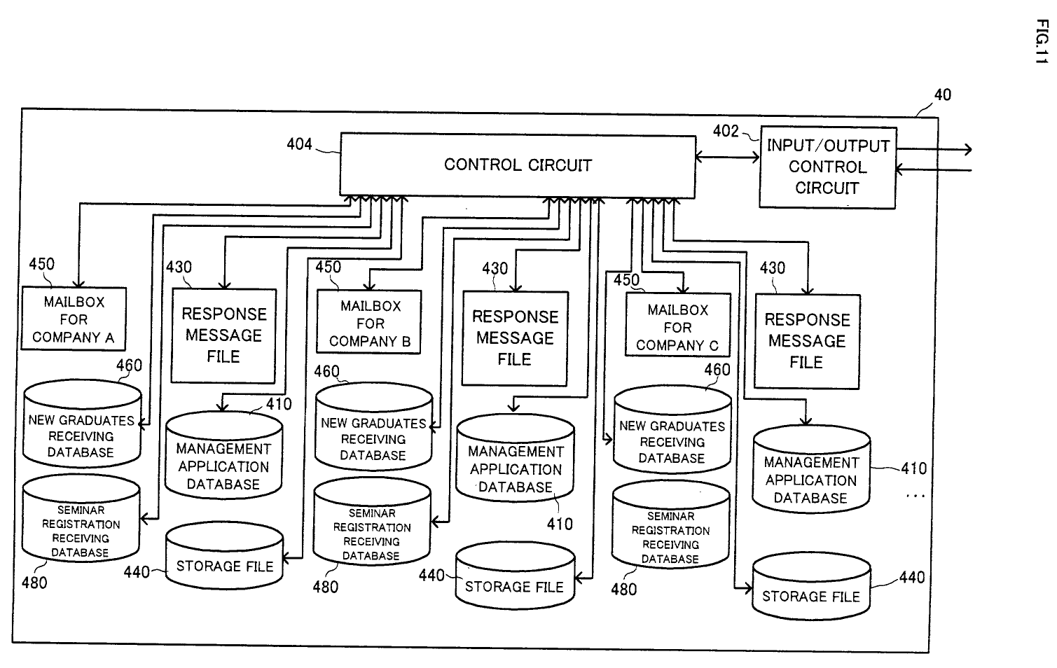

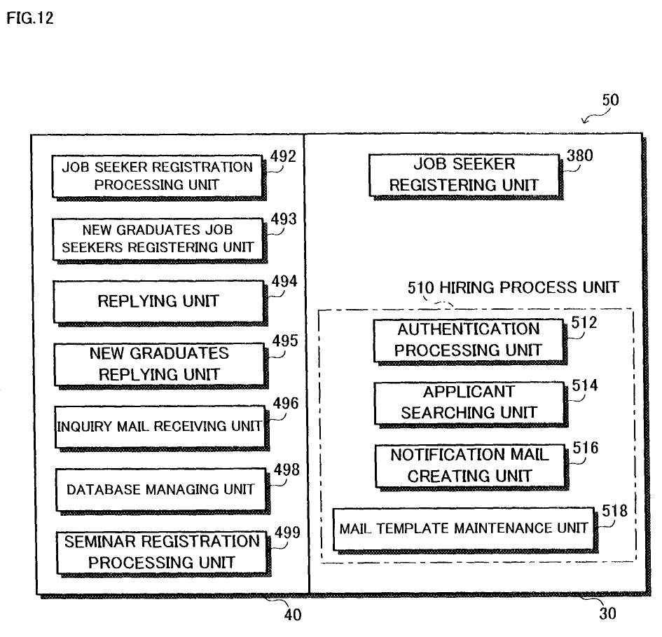

The preceding description has been mainly concerned with people looking for new jobs with hopes of moving to different companies, i.e. people to be hired midway through their careers. Of course, the above described processing may be performed in the same way for new graduates. However, as the number of people to be registered in the case of new graduates will be naturally greater, such an embodiment may implement additional processing as described below, in addition to what has been described above. As shown in FIG. 12, the management server 40 in the system 50 comprises, in addition to the components shown in FIG. 7, a new graduates job seekers registration processing unit 493 for processing registration of applicant information from new graduates, a new graduates replying unit 495, and a seminar registration processing unit 499. Also, as shown in FIG. 11, the storage device of the management server 40 comprises a new graduates receiving database 460 storing information about new graduates desiring to find jobs in the company recruiting new employees, and a seminar registration receiving database 480 for receiving registrations for attending a seminar.

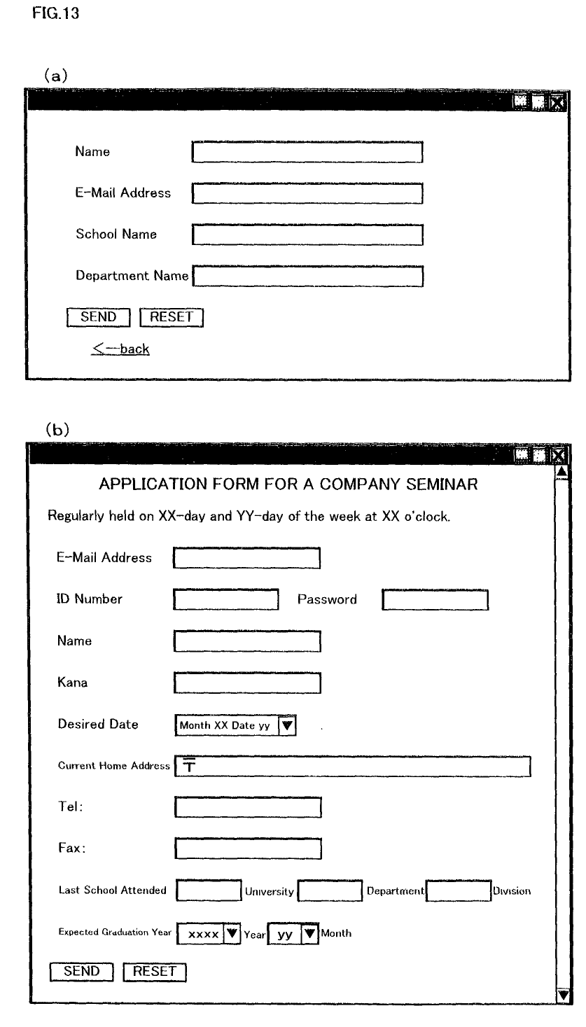

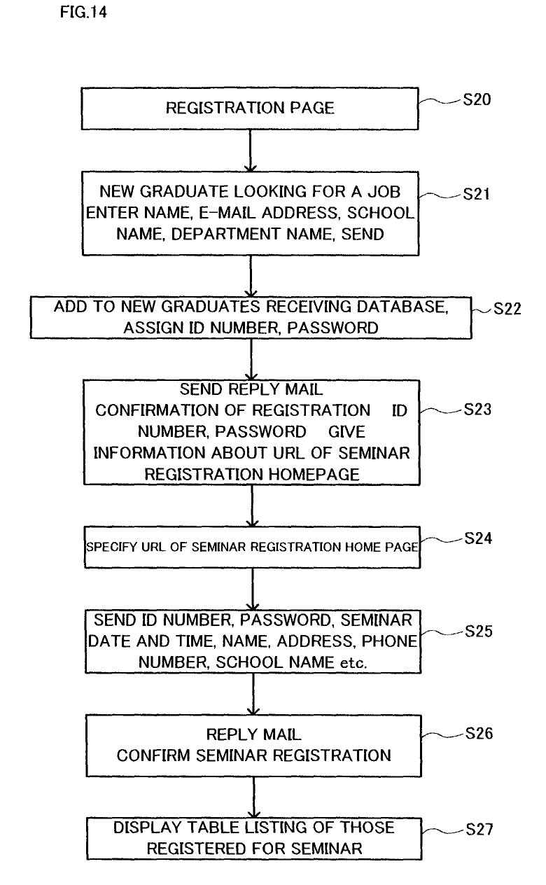

FIG. 14 is a flow chart describing this additional processing. A “new graduates hiring” button as well as a “people with experience hiring” button are provided on a hiring page of either the recruiting party server 30 or the recruiting party managed server 20 such that a link to a new graduates hiring page will be activated when clicking is made on the “new graduates hiring” button. The new graduates hiring page consists of files similar to the above described job opening announcement file 320 or job specifications files 321, 322 . . . , registration file 330. A new graduate looking for a job views job opening announcement information and job position information in the new graduates hiring page, and if he/she desires to find a job in the corresponding company recruiting new employees, clicks on the “registration” button. Then a registration page specified in the registration file will be displayed (Step S20 in FIG. 14). FIG. 13(a) shows an exemplary view of the page. In this example, registration items include name, email address, school name, and department name. When the new graduate clicks on the “send” button having finished entering information, the registration information will be transferred to the management server 40 by a script such as CGI or PHP specified in the registration file (Step S21 in FIG. 14). At this time, the corresponding name of the company recruiting new employees is added to data with a field name=“company” and transferred.

Once the applicant information from new graduates looking for jobs is transferred, a program constituting the new graduates job seekers registration processing unit 493 will be activated. After the program determines whether or not reentering of information is necessary, the above described applicant information will be added to the new graduates receiving database 460 of the corresponding company recruiting new employees (Step S22 in FIG. 14). When the applicant information from the new graduates looking for jobs arrives, ID numbers and passwords are automatically assigned to the new graduates looking for jobs as there are a large number of them. These ID numbers and passwords are added to the new graduates receiving database 460 along with the applicant information so that the latter may be managed by means of the ID numbers and passwords thereafter (of course, ID numbers and passwords may also be assigned to those seeking jobs to be hired midway through their careers such that their information would be managed by means of such numbers). Then, the new graduates replying unit 495 will be activated to create and send replay mail to email addresses data contained in the applicant information for the new graduates looking for jobs (Step S23 in FIG. 14). Such reply mail contains a registration confirmation, an ID number and a password, URLs for a seminar registration homepage and the like. FIG. 13(b) is a specific example showing a seminar registration homepage. When the URL of the seminar registration homepage or the like is specified from a client computer 10 (Step S24 in FIG. 14), the screen of this seminar registration homepage or the like prompts the new graduate to enter his/her ID number and password, as well as his/her choice of a seminar data and more detailed applicant information (for example, an address and a phone number). When the new graduate clicks on the “send” button having finished entering information, the seminar registration information will be transferred to the management server 40 by a script such as CGI or PHP specified in a display file of the seminar registration (Step S25 in FIG. 14). After the seminar registration processing unit 499 is activated to determine whether or not reentering of information is necessary, the seminar registration information will be added to the seminar registration receiving database 480. At the same time, reply mail for confirming a seminar registration will be created automatically and sent to the address of the new graduate looking for a job (Step S26 in FIG. 14). Data about those who signed up for the seminar transferred to the seminar registration receiving database 480 maybe displayed as a table listing organized according to seminar dates (Step S27 in FIG. 1). Corresponding companies recruiting new employees may also be allowed to view the listing.

As described above, the number of applicants is reduced by the imposition of such an extra process as registration for a seminar on new graduates, and the registration for a seminar is automatized, and furthermore, the registration for a seminar is commonly processed by means of a program stored in the management server 40, thus operations may be streamlined and costs to be borne by respective companies recruiting new employees may be reduced.

Thereafter, while hiring process takes various forms depending on the company recruiting new employees, respective companies recruiting new employees or the administrator may carry out the process in sequence by first copying applicant information to the applicant database 310 on the applicant server 30 targeting only those new graduates who attended a seminar, and then performing further processing by means of the above described hiring process unit 510. Alternatively, the hiring process unit 510 may be divided into a new graduates hiring process unit and a midway hiring process unit to perform separate processing. Even in this case, the basic processing may conform to the one described with reference to a hiring process in the case of hiring people midway through their careers (FIGS. 15 to 21).

While in the above description a few of the possible embodiments that may be adopted have been described with reference to the drawings, the system 50 may be implemented in various other forms within the scope of the claims.

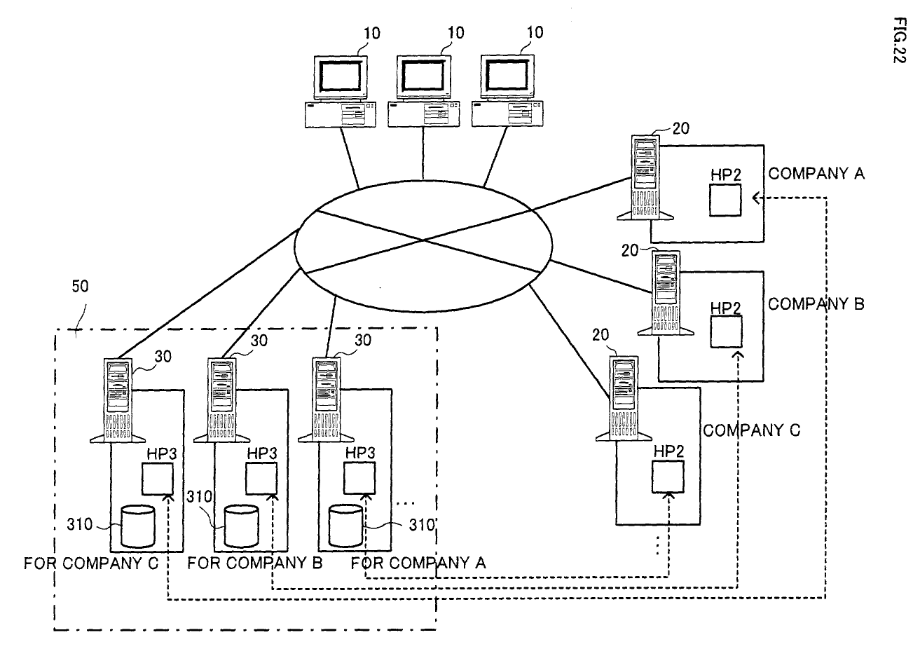

For example, as shown in FIG. 22, the management server 40 may be omitted, keeping only the recruiting party server 30. Applicant information registered by job seekers will be transferred directly to the applicant database 310 of the corresponding company recruiting new employees. The person in charge of the corresponding company recruiting new employees may also access the applicant database 310 directly. Accordingly, respective functions 492 to 499 of the management server 40 may be provided on each recruiting party server 30. Conversely, it is also possible to omit the recruiting party server 30, letting the management server 40 carry the server 30's functions, and also placing the job opening announcement file 320, the job specifications files 321, 322, 323 . . . or the registration file 330 for each company recruiting new employees on the management server 40. By accessing the management server 40 either directly or through the recruiting party managed server 20, a job seeker may view job opening announcements and job specifications of each company recruiting new employees, and also sign up to a company recruiting new employees where he/she desires to find a job.

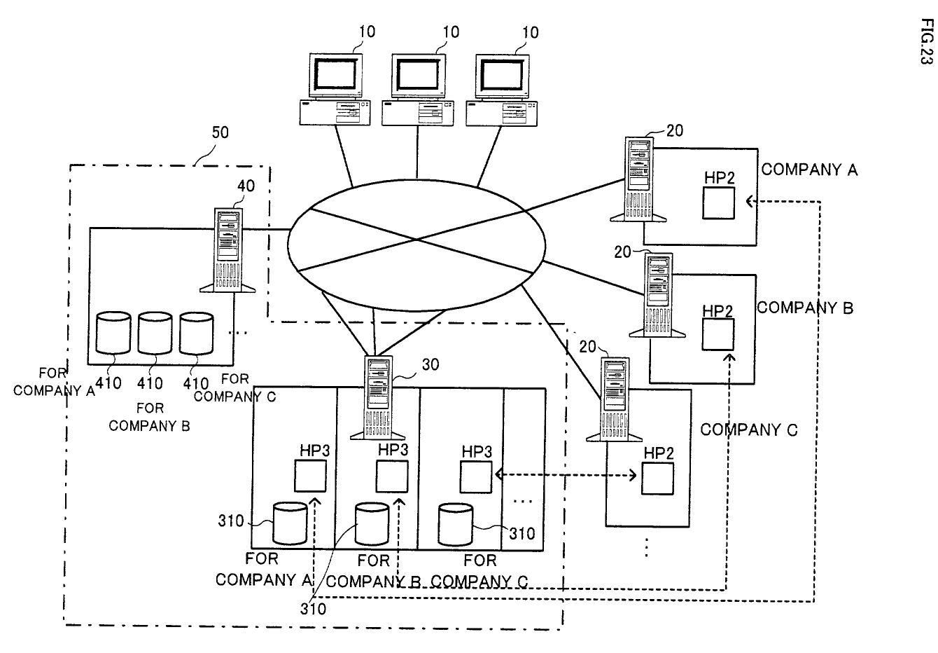

Alternatively, as shown in FIG. 23, rather than providing as many recruiting party severs 30 as companies recruiting new employees subscribing to the system 50, it is also possible to make the number of servers fewer than the number of the companies recruiting new employees. Nevertheless, like the case shown in FIG. 1, homepages HP3 with different URLs are still provided for respective companies recruiting new employees.

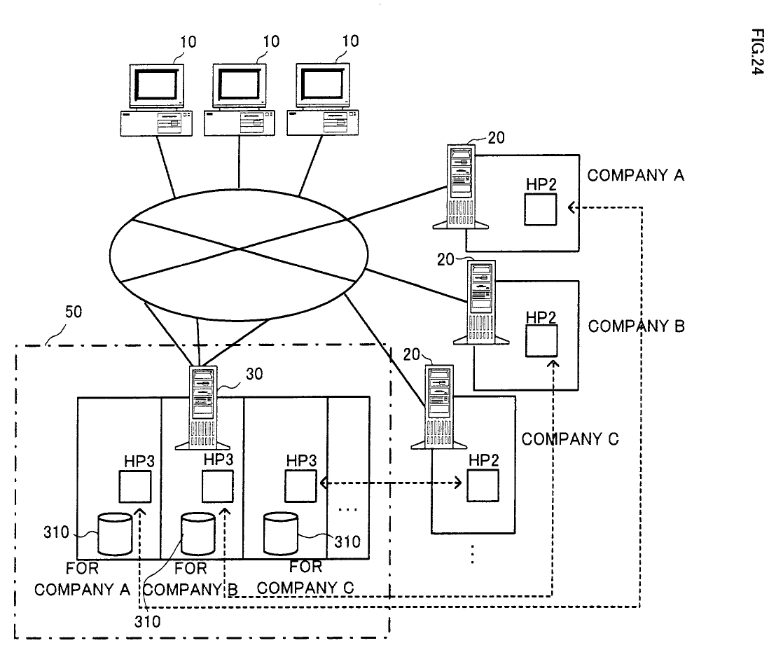

Moreover, as shown in FIG. 24, the management server 40 shown in FIG. 23 may also be omitted, leaving only the recruiting party server 30. Applicant information entered by a job seeker will be transferred directly to the applicant database 310 of a corresponding company recruiting new employees.

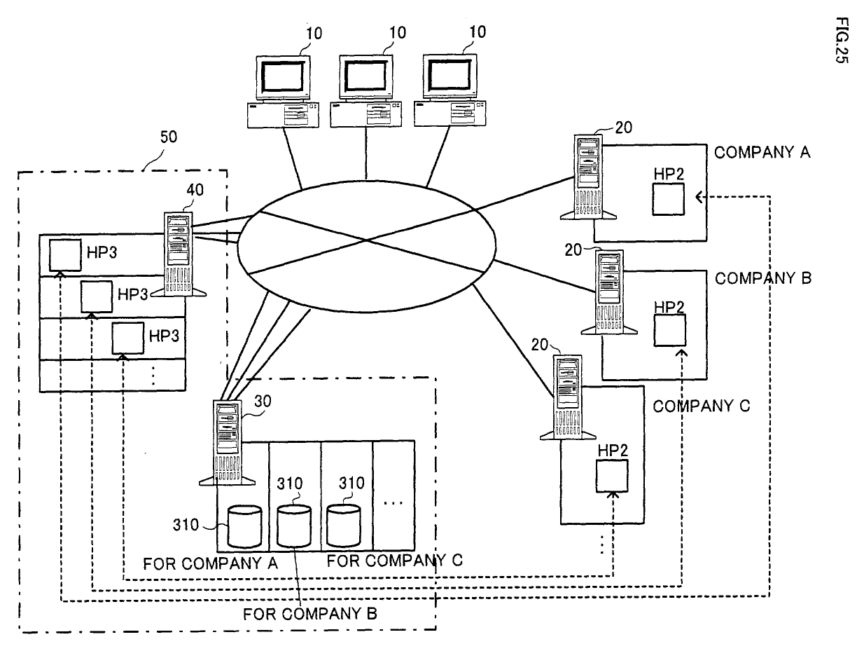

Moreover, as shown in FIG. 25, the management applicant database 410 may also be omitted, leaving only the applicant database 310, and storing the applicant database 310 and the homepage HP3 respectively in different servers.

Alternatively, though not illustrated, a company recruiting new employees may directly access the management application database 410 corresponding to the company to view applicant information without providing an applicant database 310 in the recruiting party server 30 unlike the case in FIG. 1. In this case, the management applicant database 410 will be managed through the use of passwords so that only the administrator and the corresponding companies recruiting new employees may view information.

Alternatively, and optionally, though not shown in the drawings, among the job opening announcement file 320, job specifications files 321, 322, 323 . . . and registration file 330, only the registration file may be placed on the management server 40.

Alternatively, rather than providing a plurality of management applicant databases 410 or a plurality of applicant databases 310 for respective companies recruiting new employees on the management server 40 or recruiting party server 30, information may be managed by means of a single database. In this case, job search information may be identified for respective companies recruiting employees by the company field.

In this way, any variations are possible, and the present invention is not limited in terms of the-number of servers, the number of databases, or the irrespective housing locations. Nor is it limited in terms of respective storage locations of various files in screen files such as homepages.

Furthermore, preferably, security may be enhanced by encrypting registration data from job seekers.

Industrial Applicability

As described above, according to the invention, by managing all the applicant information from job seekers who applied for jobs at recruiting parties subscribing to this system as a whole, the administrator may perform substantial portions of the operations assigned to people in charge of recruitment and the like on their behalf. As the administrator performs processing across all the recruiting parties subscribing to the system, operations may be streamlined and costs to be borne by respective recruiting parties may be greatly reduced. As a screen display of recruitment information and the like are prepared by each recruiting party, information may be displayed in a highly flexible manner to give expression to characters of the recruiting party.

1. A recruitment and job search information which is a computer system for processing recruitment and job search information utilizing a communication network such as the Internet, comprising:
recruiting party information storing means for storing recruitment information relative to a plurality of recruiting parties for each recruiting party separately, wherein the stored recruitment information can be viewed from a client device operated by a job seeker accessing the information via the communication network by specifying a particular recruiting party among the plurality of recruiting parties;
applicant information storing means for storing information concerning job seekers applying for jobs at said recruiting parties (hereafter referred to as applicant information), for each recruiting part separately; and
job seeker registering means for prompting the client device operated by a job seeker accessing by means of the communication network by specifying a particular recruiting party among said plurality of recruiting parties to enter applicant information so as to classify the entered applicant information according to said specified recruiting party and store the information in said applicant information storing means,
wherein the applicant information stored separately for each recruiting party in the applicant information storing means is managed and administered.

2. A recruitment and job search information which is a computer system for processing recruitment and job search information utilizing a communication network such as the Internet, comprising:
applicant information storing means for storing information concerning job seekers applying for jobs at said recruiting parties (hereafter referred to as applicant information), for each recruiting part separately;
a recruiting party server having a different URL for each recruiting party on the communication network, capable of being accessed by a client device by means of the communication network, and storing corresponding recruitment information, wherein the recruitment information maybe transferred to the client device via the communication network to be displayed on the device, and wherein the client device may be prompted to enter applicant information of the job seekers applying for jobs at the recruiting parties; and
job seeker registering means for storing in said applicant information storing means applicant information transferred via said communication network by means of the client device by relating the information to the recruiting party corresponding to the URL of the recruiting party server accessed at the time of registration,
wherein the applicant information stored in the applicant information storing means and related to the recruiting party is managed and administered.

3. The recruitment and job search information processing system according to claim 2, wherein said recruitment information stored in said recruiting party server (30) is hyperlinked on the communication network with other information concerning the recruiting party not related to recruitment stored on a recruiting party managed server (20) which can be accessed by a client device (10) and managed by the recruiting party.

4. The recruitment and job search information processing system according to claim 3, wherein the URL of said recruiting party server contains a character string that represents the name of said recruiting party.

5. The recruitment and job search information processing system according to any one of claims 1 to 4, wherein said job seeker registering means stores applicant information in said applicant information storing means for each recruiting party separately based on recruiting party data attached to the applicant information and indicating which recruiting party is concerned with the application from the recruiting party.

6. The recruitment and job search information processing system according to any one of claims 1 to 5 further comprising replying means wherein once said job seeker registering means stores applicant information in the applicant information storing means, email addresses contained in said applicant information are extracted to create and send back reply mail addressed to the email addresses.

7. The recruitment and job search information processing system according to anyone of claims 1 to 6 wherein the applicant information stored separately for each recruiting party in said applicant information storing means is accessible to a recruiting party device operated by a corresponding recruiting party by means of the communication network.

8. The recruitment and job search information processing system according to any one of claims 1 to 7 wherein said applicant information storing means may store status information indicating a status of job seekers in a hiring process in addition to the applicant information of applicants entered by the applicants.

9. The recruitment and job search information processing system according to claim 8 wherein said status information includes evaluation information indicating an evaluation of the job seeker made by said recruiting party.

10. The recruitment and job search information processing system according to claim 9 wherein said evaluation information includes hiring result indicating whether or not to hire the job seeker.

11. The recruitment and job search information processing system according to any one of claims 8 to 10 wherein said status information includes notification information indicating whether or not communication has been made to a corresponding job seeker.

12. The recruitment and job search information processing system according to anyone of claims 1 to 11 further comprising notification mail creating means for extracting email addresses from said applicant information from applicants to create notification mail addressed to the addresses for communicating about interviews, a seminar, or the like.

13. The recruitment and job search information processing system according to any one of claims 8 to 11 wherein said status information is accessible to a recruiting party device operated by a corresponding recruiting party by means of the communication network, and wherein different access rights are provided depending on which member of the recruiting party is operating said recruiting party device.
